(19) United States
(12) Patent Application Publication
(10) Pub. No.: US 2018/0074820 A1
(43) Pub. Date: Mar. 15, 2018

(54) DETERMINING STRUCTURAL INFORMATION ABOUT SOFTWARE DEVELOPMENT PROJECTS

(71) Applicant: International Business Machines Corporation, Armonk, NY (US)

(72) Inventors: Amol A. Dhondse, Pune (IN); Agnieszka K. Marzantowicz, Warsaw (PL); Lukasz J. Paciorkowski, Warsaw (PL); Anand Pikle, Pune (IN); Gandhi Sivakumar, Bentleigh (AU)

(21) Appl. No.: 15/813,680

(22) Filed: Nov. 15, 2017

Related U.S. Application Data
(63) Continuation of application No. 15/208,644, filed on Jul. 13, 2016.

(51) Int. Cl. G06F 9/44

(52) U.S. Cl. CPC G06F 8/77

(57) ABSTRACT

A computer-implemented method comprises identifying a software development project profile and identifying one or more project activity data artefacts associated with the software development project profile. The computer-implemented method further comprises determining one or more structured project activity data artefacts based on the one or more project activity data artefacts and determining one or more structural mapping conclusions based on the one or more structured project activity data artefacts. The computer-implemented method further comprises determining one or more project structural conclusions associated with the software development project profile based on the one or more structural mapping conclusions. A corresponding computer program product and computer system are also disclosed.

### BACKGROUND

The present invention relates generally to the field of software development platforms, and more particularly to determining structural information about software developments projects in those platforms.

In software development platforms, structural information about software development projects (e.g., the use case model or the operational model associated with software development projects) play a key role in facilitating software development activities in the context of such platforms. As such, the method of determining structural information about software development projects is key to the performance and user-friendliness of such software development platforms. Developers and users of software development platforms continue to strive to improve the performance and user-friendliness of such systems.

### SUMMARY

A computer-implemented method comprises identifying a software development project profile and identifying one or more project activity data artefacts associated with the software development project profile. The computer-implemented method further comprises determining one or more structured project activity data artefacts based on the one or more project activity data artefacts and determining one or more structural mapping conclusions based on the one or more structured project activity data artefacts. The computer-implemented method further comprises determining one or more project structural conclusions associated with the software development project profile based on the one or more structural mapping conclusions. A corresponding computer program product and computer system are also disclosed.

### BRIEF DESCRIPTION OF THE DRAWINGS

FIG. 1 is a block diagram of one embodiment of a computer system environment suitable for operation of a project activity structuring program, in accordance with at least one embodiment of the present invention.

FIG. 2 is a data flow diagram of a project activity structuring program, in accordance with at least one embodiment of the present invention.

FIG. 3 is a flowchart diagram of a project activity structuring program, in accordance with at least one embodiment of the present invention.

FIG. 4 is a block diagram of a computing apparatus suitable for executing a project activity structuring program, in accordance with at least one embodiment of the present invention.

### DETAILED DESCRIPTION

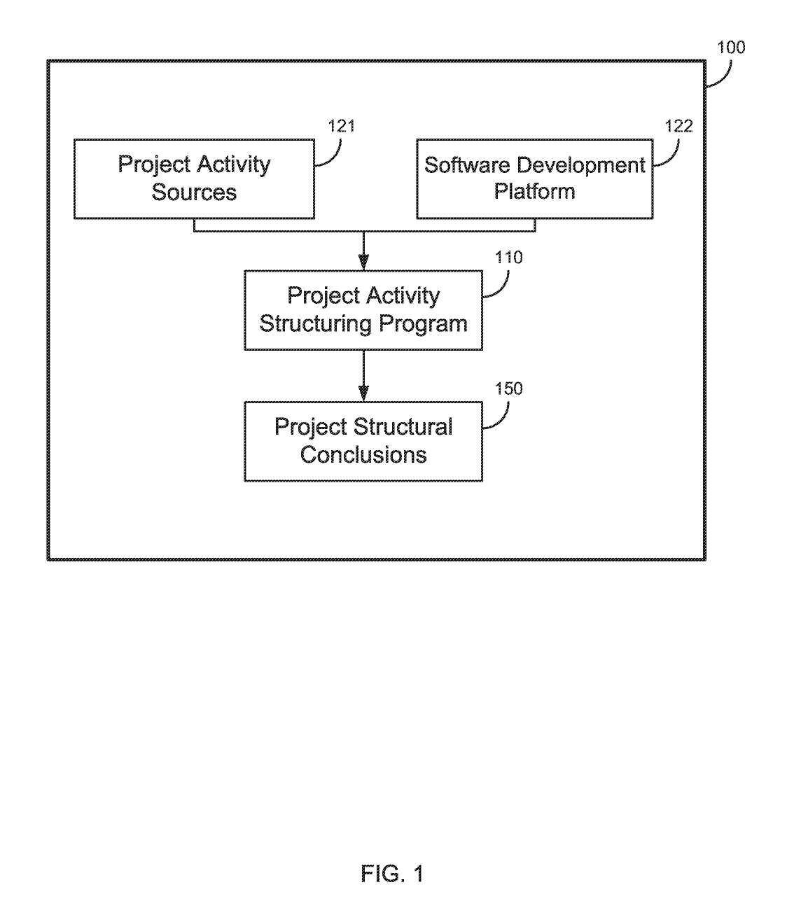

FIG. 1 is a computer system environment 100 suitable for operating a project activity structuring program 110, in accordance with at least one embodiment of the present invention. In the computer system environment 100 depicted in FIG. 1, the program 110 receives at least one information artefact from one or more project activity sources 121. In at least some embodiments, a project activity source 121 is any combination of one or more computer (hardware and/or software) components that, in whole or in part, include at least one indication of at least one project activity data artefact. In at least some embodiments, a project activity data artefact is any data artefact that, in whole or in part and directly or when interpreted along with other one or more data artefacts, indicate at least one information artefact about a software development project, such as one or more information artefacts about at least one of the following: (i) the progress status of the software development project; (ii) user inputs regarding the structure and/or planning of the software development project; (iii) the operational environment of the software development project; and (iv) the use case model of the software development project.

In the computer system environment 100 depicted in FIG. 1, the project activity structuring program 110 receives at least one information artefact from a software development platform 122. In at least some embodiments, a software development platform 122 is any combination of one or more computer (hardware and/or software) components that, in whole or in part, enable at least one user activity related to the design and/or implementation of at least part of a software development project (such as the design of at least one use case model and/or at least one operational model associated with at least part of the software development project). Examples of software development platforms 122 include platforms that use the Unified Modeling Language (UML) for software design, such as IBM's Rational Software Architect and Rational Software Modeler. Examples of software development platforms 122 also include platforms that enable modeling the system architecture associated with a software development project, such as the Unicom System Architect. Examples of software development platforms 122 also include platforms that are used to design and/or implement database systems associated with software development projects, such as platforms that use the Structured Query Language (SQL) for database design.

In the computer system environment 100 depicted in FIG. 1, the project activity structuring program 110 uses the data artefacts provided by the one or more project activity sources 121 and the software development platform 122 to determine one or more project structural conclusions 150. In at least some embodiment, a project structural conclusion is any combination of one or more data artefacts that, in whole or in part and directly or when interpreted along with other one or more data artefacts, indicate at least one determination and/or estimation about how a software development project should be designed and/or implemented. In some embodiments, the one or more project structural conclusions comprise 150 at least one conclusion about the use case model of a software development project. In at least some embodiments, a use case model associated with a software development project is any combination of one or more data artefacts that determine and/or suggest at least one functionality of the software development project, for instance using use case diagrams to represent units of functionality performed by the software development project. In some embodiments, the one or more project structural conclusions comprise 150 at least one conclusion about the operational model of a software development project. In at least some embodiments, an operational model associated with a software development project is any combination of one or more data artefacts that determine and/or suggest at least one element of a computer system environment within which the software development project may operate.

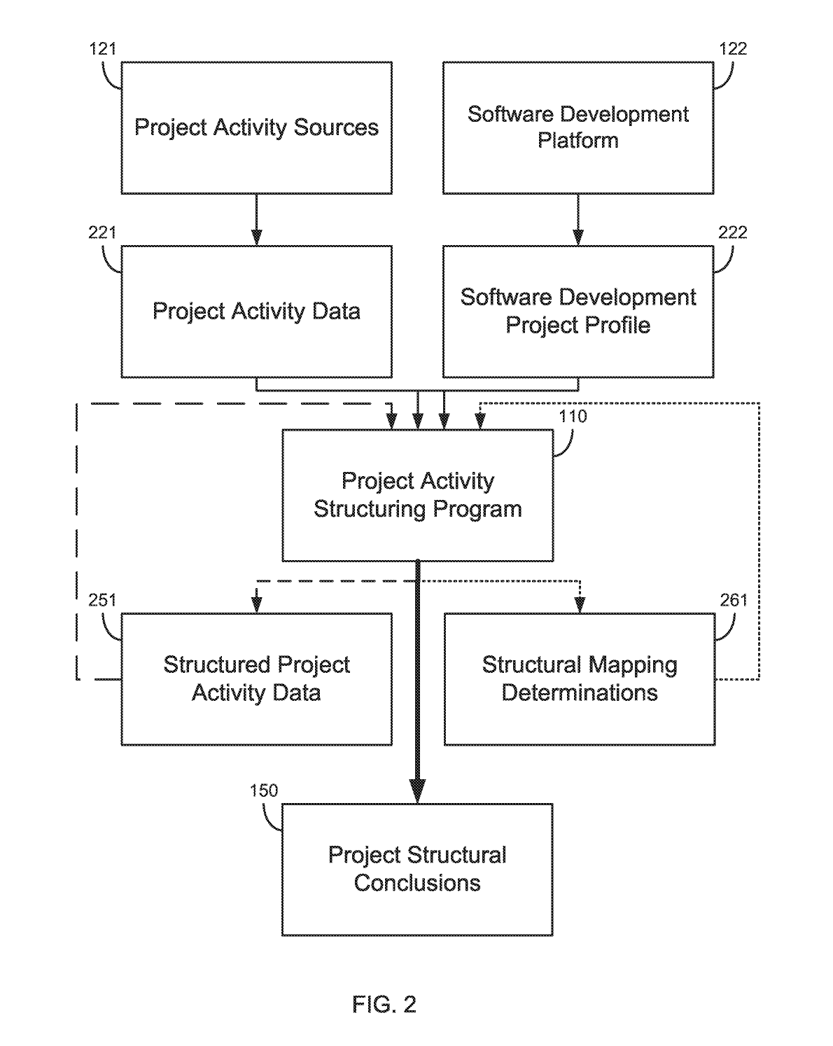

FIG. 2 is a data flow diagram of a project activity structuring program 110, in accordance with at least one embodiment of the present invention. In the embodiment depicted in FIG. 2, the program 110 receives one or more project activity data artefacts 221 from one or more project activity sources 121. In the embodiment depicted in FIG. 2, the program 110 receives a software development project profile 122 from the software development platform 122. In at least some embodiments, a software development project profile 122 is any combination of one or more data artefacts that, in whole or in part and directly or when interpreted along with other one or more data artefacts, indicate at least one information artefact about at least one property (e.g., identity, system needs, expected functionality, etc.) associated with a software development project.

In the embodiment depicted in FIG. 2, the project activity structuring program 110 uses the one or more project activity data artefacts 221 (e.g., along with the software development project profile 222) to determine one or more structured project activity data artefacts 251. In at least some embodiments, the one or more structured project activity data artefacts 251 comprise a structured taxonomy of at least one of the one or more project activity data artefacts 221. In some embodiments, a structured taxonomy of the one or more project activity data artefacts 221 comprise at least one of a hierarchy of at least one of the one or more project activity data artefacts 221, a classification of at least one of the one or more project activity data artefacts 221, and a transformation of at least one of the one or more project activity data artefacts 221 into at least one predefined format.

In the embodiment depicted in FIG. 2, the project activity structuring program 110 uses the one or more structured project activity data artefacts 251 and the software development project profile 222 to determine one or more structural mapping conclusions 261. In at least some embodiments, a structural mapping conclusion is any combination of one or more data artefacts that, in whole or in part and directly or when interpreted along with other one or more data artefacts, indicate at least one determination and/or estimation about at least one correlation between at least one property associated with a software development project and at least one of the one or more structured project activity data artefacts 251. In some embodiments, a structural mapping conclusion demonstrates that a particular project activity data artefact 221 relates to at least one specific property of the software development project, such as the functionality or system environment of the software development project. In the embodiment depicted in FIG. 2, the program 110 uses the one or more structural mapping conclusions 261 to determine the one or more project structural conclusions 150.

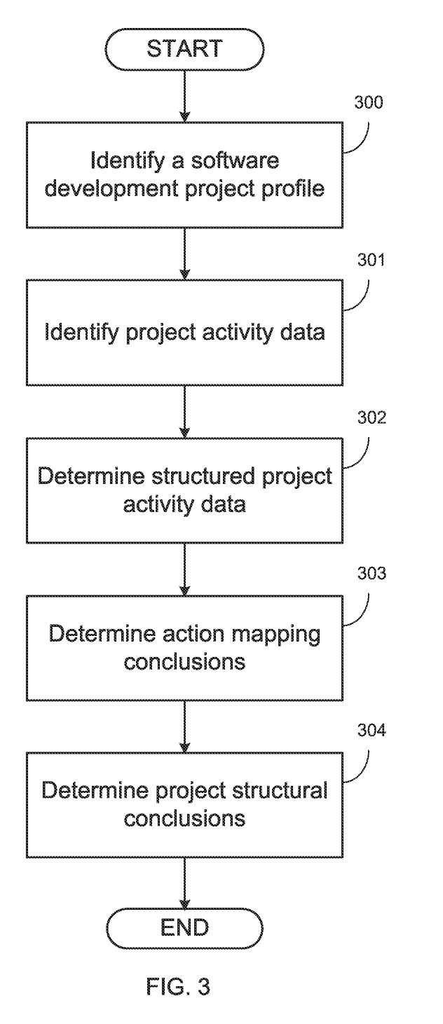

FIG. 3 is a flow-chart diagram of a project activity structuring program, in accordance with at least one embodiment of the present invention. At step 300, the program identifies a software development project profile. At step 301, the program identifies one or more project activity data artefacts associated with the software development project profile. At step 302, the program determines one or more structured project activity data artefacts based on the one or more project activity data artefacts. At step 303, the program determines one or more structural mapping conclusions based on the one or more structured project activity data artefacts. At step 304, the program determines one or more project structural conclusions associated with the software development project profile based on the one or more structural mapping conclusions.

The project activity structuring program identifies a software development project profile at step 300. In some embodiments, the program identifies the software development project profile based on at least one data artefact received from a software development platform. In some embodiments, the program periodically (e.g., every 1 millisecond) checks a directory of software development projects (e.g., maintained by the software development platform) to identify the software development project profile. In some embodiments, the software development platform is associated with one or more object-oriented project modeling data artefacts. In some embodiments, the software development platform is associated with one or more relational database project modeling data artefacts.

In at least some embodiments, the one or more object-oriented project modeling data artefacts are any combination of one or more data artefacts that, in whole or in part and directly or when interpreted along with other one or more data artefacts, indicate at least one information artefact about the design of at least part of a software development project using a design technique, protocol, and/or language that relies on an object-oriented model of programming (e.g., UML and/or a UML-based design protocol). In at least some embodiments, the one or more relational database project modeling data artefacts are any combination of one or more data artefacts that, in whole or in part and directly or when interpreted along with other one or more data artefacts, indicate at least one information artefact about the design of at least part of a software development project using a design technique, protocol, and/or language that relies on a relational model of database design (e.g., a SQL-based design protocol).

The project activity structuring program identifies the one or more project activity data artefacts at step 301. In some embodiments, the program extracts the one or more project activity data artefacts from one or more project activity source data artefacts (e.g., by utilizing one or more learning algorithms). In some embodiments, the program identifies the one or more project activity data artefacts by receiving at least one data artefact from a project activity source, wherein a project activity source is any combination of one or more computer (hardware of software) components that, in whole or in part, (i) determine and/or receive at least one input data artefact from at least one user profile and/or user account related to the software development project; and/or (ii) include and/or determine at least one data artefact related to the software development project. In some embodiments, the one or more project activity data artefacts are identified based on one or more project activity sources selected from the group consisting of: one or more group collaboration sources; one or more mail channel sources; one or more documentation sources; one or more organization historical data sources; and one or more audiovisual conference record sources.

In at least some embodiments, a group collaboration source (e.g., a group messaging and/or group chat platform) is any combination of one or more computer (hardware of software) components that, in whole or in part, enable at least one user to communicate with one or more additional users (e.g., in real time). In at least some embodiments, a mail channel source (e.g., an email group) is any combination of one or more computer (hardware of software) components that, in whole or in part, enable at least one user to email one or more additional users. In at least some embodiments, a documentation source (e.g., a collectively produced documentation source for a software development project) is any combination of one or more data artefacts that, in whole or in part and directly or when interpreted along with other one or more data artefacts, indicate at least one information artefact about at least one proposal for the design and/or implementation of the software development project. In at least some embodiments, an organization historical data source (e.g., past product release specifications) is any combination of one or more data artefacts that, in whole or in part and directly or when interpreted along with other one or more data artefacts, indicate at least one information artefact that are identified as produced and/or documented by at least one organization associated with the software development project. In at least some embodiments, an audiovisual conference record source (e.g., the recording of an audiovisual conference) is any combination of one or more data artefacts that, in whole or in part and directly or when interpreted along with other one or more data artefacts, indicate at least one information artefact about at least one audio, visual, and/or audiovisual meeting and/or conference between one or more users.

The project activity structuring program determines the one or more structured activity data artefacts at step 302. In some embodiments, the program determines the one or more structured activity data artefacts based on a formatting of the one or more project activity data artefacts into at least one predefined data format and/or data taxonomy. In some embodiments, determining the one or more structured activity data artefacts comprises determining at least one of a hierarchy of at least one of the one or more project activity data artefacts, a classification of at least one of the one or more project activity data artefacts, and a transformation of at least one of the one or more project activity data artefacts into at least one predefined format. In some embodiments, the program interacts with a data structuring engine to determine the one or more structured activity data artefacts (e.g., by supplying an indication of the one or more project activity data artefacts as an input and receiving an indication of the one or more structured project activity data artefacts as an output).

The project activity structuring program determines the one or more structural mapping conclusions at step 303. In some embodiments, the program utilizes at least one learning algorithm to determine the one or more structural mapping conclusions. In some embodiments, the program interacts with a structural mapping conclusion generation engine to determine the one or more structural mapping conclusions (e.g., by supplying an indication of the one or more structured project activity data artefacts as an input and receiving an indication of the one or more structural mapping conclusions as an output),In some embodiments, determining the one or more structural mapping conclusions further comprises: (i) determining one or more natural language analysis conclusions based on the one or more structured project activity data artefacts; (ii) determining one or more data segmentation conclusions based on the one or more natural language analysis conclusions; and (iii) determining one or more cognitive inferential conclusions based on said one or more data segmentation conclusions. In some embodiments, the program determines the one or more structural mapping conclusions based on one or more legacy statistical data artefacts associated with each of the one or more project activity data artefacts (as defined below).

In at least some embodiments, a natural language analysis conclusion determined based on the one or more structured project activity data artefact is any combination of one or more data artefacts that, in whole or in part and directly or when interpreted along with other one or more data artefacts, indicate at least one determination and/or estimation about the linguistic, semantic, and/or textual features associated with at least one of the one or more structured project activity data artefacts. In at least some embodiments, a data segmentation conclusion determined based on the one or more natural language conclusions is any combination of one or more data artefacts that, in whole or in part and directly or when interpreted along with other one or more data artefacts, indicate at least one determination and/or estimation about the relative significance of at least one of the one or more structured project activity data artefacts and/or at least one of the one or more project activity data artefacts to the analysis of the project activity structuring program. In at least some embodiments, a cognitive inferential conclusion determined based on the one or more data segmentation conclusion is conclusions is any combination of one or more data artefacts that, in whole or in part and directly or when interpreted along with other one or more data artefacts, indicate at least one determination and/or estimation about the relationship between the following two elements: (i) at least one of the one or more structured project activity data artefacts and/or at least one of the one or more project activity data artefacts; and (ii) at least one of the other one or more structured project activity data artefacts and/or at least one of the other one or more project activity data artefacts.

The project activity structuring program determines the one or more project structural conclusions at step 304. In some embodiments, the program interacts with a project structural conclusions engine to determine the one or more structured activity data artefacts (e.g., by supplying an indication of the one or more structural mapping conclusions as an input and receiving an indication of the one or more project structural conclusions as an output). In some embodiments, the one or more project structural conclusions are selected from the group consisting of: one or more use case model conclusions; and one or more operational model conclusions. In some embodiments, the program further comprises identifying a computer software environment data object associated with the software development project profile; and identifying a computer hardware environment data object associated with the software development project profile. In at least some of those embodiments, the one or more use case model conclusions are determined based on the computer software environment data object; and the one or more operational model conclusions are determined based on the computer hardware environment data object.

In at least some embodiments, a data object is a combination of one or more data artefacts (whether or not contiguously stored on a computer-readable storage media unit or whether or not stored on a single computer-readable storage media unit). In some embodiments, a computer software environment data object is any data object that, in whole or in part and directly or when interpreted along with one or more other data objects, indicate at least one information artefact about the software architecture of at least one embodiment of the software development project identified by the software development project profile and/or about at least one computer software component with which at least one embodiment of the software development project identified by the software development project profile interacts. In at least some embodiments, a computer hardware environment data object is any data object that, in whole or in part and directly or when interpreted along with one or more other data objects, indicate at least one information artefact about the at least one hardware requirement for at least one embodiment of the software development project and/or at least one computer hardware environment with which at least one embodiment of the software development project identified by the software development project profile interacts. In some embodiments, the project activity structuring program determines one or more software development documentation data objects (i.e., one or more data artefacts indicating at least a part of a use case model, operational model, and/or other documentation information repository) based on the one or more project structural conclusions.

In some embodiments, determining the one or more project structural conclusions further comprises: determining one or more use case characterizations associated with the software development project profile based on the one or more structural mapping conclusions and determining, for each of the one or more project activity data artefacts, one or more legacy statistical data artefacts. In at least some embodiments, a use case characterization associated with the software development project profile is any data artefact that, in whole or in part and directly or when interpreted along with other one or more data artefacts, indicates at least one information artefact about at least one use case model and/or at least one use case associated with the software development project. In some embodiments, a legacy statistical data artefact associated with a project activity data artefact is any data artefact that, in whole or in part and directly or when interpreted along with other one or more data artefacts, indicates at least one information artefact about the determined and/or estimated relationship and/or correlation between the project activity data artefact and at least one project structural conclusions and/or at least category of project structural conclusions within a particular period of time (e.g., the last month prior to the determination). In some embodiments, the project activity structuring program uses the one or more legacy statistical data artefacts to assist in future project structural conclusion determinations.

In some embodiments, the project activity structuring program comprises at least one of the following computer (hardware or software) components: a data collector, a raw data processor, a natural language classification engine, a data segment analyzer, a cognitive molder, and a digital engagement steward. The data collector collects at least one of the following: chat data, mail channel data, conference data, documentation data (e.g., biz requirements case, proposals), customer relationship management data, and historical data. The raw data processor performs at least one of the following: (i) filtering the portion of the data describing the requirements of the software development profile; (ii) retrieving relevant structural data from sources internal to the software development project profile; (iii) retrieving data pertaining to use cases and specifications; and (iv) transforming and normalizing data from multiple sources into a structured taxonomy for further analysis. The natural language classification engine uses natural language interpretation and classification capabilities on structured and unstructured data to perform user characteristic to determine action mapping conclusions. The data segment analyzer performs multi-dimensional data aggregation and relationship analysis to enable insights about the specific use cases and related dimensions associated with the software development project profile. Cognitive modeler performs cognitive reasoning and analysis on the processed data for co-relation and deriving inferences related to the software development project profile. The digital engagement steward performs at least one of the following: (i) defining architectural boundaries for specific use cases and/or operational environment elements; (ii) performing statistical analysis on different set of inputs like those associated with project management, performance engineering, etc.; (iii) defining opportunities based on the inputs provided; and (iv) determining key prompts and invoking architectural key words to determine action mapping conclusions.

In some embodiments, the project activity structuring program further comprises identifying a user profile, determining one or more project development information artefacts based on one or more project structural conclusions, and presenting the one or more project development information artefacts to the user profile. In some embodiments, the one or more project development information artefacts comprise at least one of one or more source information artefacts, one or more historical project structure information artefacts, and one or more conclusion indicator information artefacts; and presenting the one or more source information artefacts to the user profile is performed in response to identifying a mouse cursor input indicator associated with at least one of the one or more project development information artefacts.

In at least some embodiments, a project development information artefact is any information artefact about a possible and/or suggested design of a software development project and/or the past design and/or suggested design of a software development project. In at least some embodiments, a source information artefact is any information artefact about at least one association between at least project structural conclusion and at least one project activity data artefact and/or at least one structured project activity data artefact. In at least some embodiments, a historical project structure information artefact is any information artefact about the design and/or suggested design of a past software development project, and/or about at least one project structural conclusion associated with a past software development project. In some embodiments, at least one historical project structure information artefact is determined based on the historic activity associated with the user profile. In at least some embodiments, a conclusion indicator information artefact is any information artefact that includes at least one indication to at least one project structural conclusion. In at least some embodiments, a mouse cursor input indicator associated with a project development information artefact is any data artefact that, in whole or in part and directly or when interpreted with one or more other information artefacts, indicates that, at least in one time, a cursor associated with a computer mouse (and/or other similar computer pointer input device) has been placed on at least one screen location associated with the project development information artefact.

In some embodiments, the project activity structuring program interacts with at least one data artefact associated with the role and/or history of a user profile associated with the program. In some embodiments, the project activity structuring program triggers a digital engagement apparatus based on the cursor placement in the program. In some embodiments, the program invokes the tool based on the role of the user in the development team and/or historical data associated with the project, the team, and/or the user. In some embodiments, the program picks key prompts and/or invokes architectural keywords. In some embodiments, each key prompt and/or architectural keyword is associated and/or mapped with at least one action. In some embodiments, the program specifies the details of a chart developed based on historic data interactively (e.g., in response to cursor placement in the program). In some embodiments, the program constructs one or more architecture building blocks based on the one or more project structural conclusions. In some embodiments, the architectural building blocks are constructed based on input derived from user digital engagement profile and/or historic data.

In some embodiments, the project activity structuring program operates as part of a software development platform, while in other embodiments the project activity structuring program is part of an stand-alone software component that communicates with the a software development platform and/or can be optionally added as an add-on program to the software development platform. In general, one or more steps associated with different embodiments of the project activity structuring program may be performed based on one or more pieces of information obtained directly or indirectly from one or more computer (hardware or software) components, one or more pieces of information obtained directly or indirectly from one or more inputs from one or more users, and/or one or more observed behaviors associated with one or more (hardware or software) components of one or more computer system environments. In general, one or more steps of different embodiments of the project activity structuring program may comprise communicating with one or more computer (hardware or software) components, issuing one or more computer instructions (e.g., one or more special purpose machine-level instructions defined in the instruction set of one or more computer hardware components), and/or communicating with one or more computer components at the hardware level.

Embodiments of the present invention enable determination of structural information about software development projects without the need for direct user activity by inferring such information from unstructured or structured information provided by users during the development process. As such, embodiments of the present invention enable features that make software development platforms more user-friendly and/or improve the performance of such platforms by removing the need for error-prone user determination of structural information associated with software development projects. The inventors have recognized that, by using learning algorithms and other forms of data analysis, structural information about software development projects can be determined without the need for direct determination of such information by users. Nevertheless, the aforementioned advantages are not required to be present in all of the embodiments of the invention and may not be present in all of the embodiments of the invention.

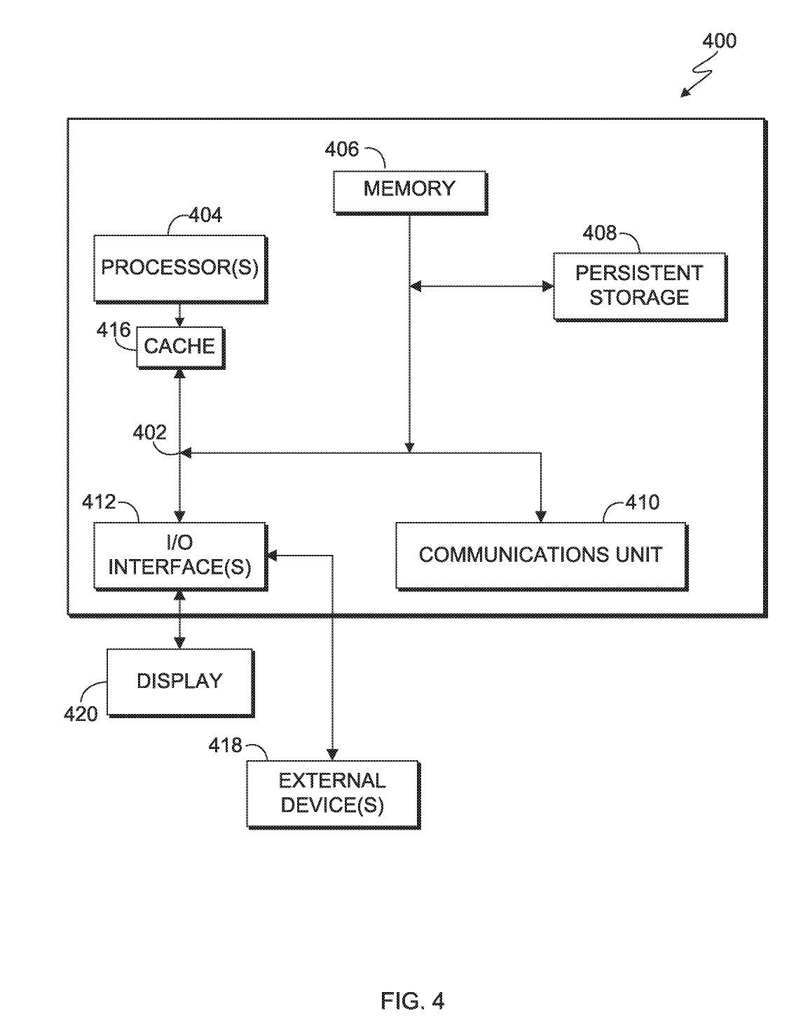

FIG. 4 is a block diagram depicting components of a computer 400 suitable for executing the project activity structuring program. FIG. 4 displays the computer 400, the one or more processor(s) 404 (including one or more computer processors), the communications fabric 402, the memory 406, the RAM, the cache 416, the persistent storage 408, the communications unit 410, the I/O interfaces 412, the display 420, and the external devices 418. It should be appreciated that FIG. 4 provides only an illustration of one embodiment and does not imply any limitations with regard to the environments in which different embodiments may be implemented. Many modifications to the depicted environment may be made.

As depicted, the computer 400 operates over a communications fabric 402, which provides communications between the cache 416, the computer processor(s) 404, the memory 406, the persistent storage 408, the communications unit 410, and the input/output (I/O) interface(s) 412. The communications fabric 402 may be implemented with any architecture suitable for passing data and/or control information between the processors 404 (e.g., microprocessors, communications processors, and network processors, etc.), the memory 406, the external devices 418, and any other hardware components within a system. For example, the communications fabric 402 may be implemented with one or more buses or a crossbar switch.

The memory 406 and persistent storage 408 are computer readable storage media. In the depicted embodiment, the memory 406 includes a random access memory (RAM). In general, the memory 406 may include any suitable volatile or non-volatile implementations of one or more computer readable storage media. The cache 416 is a fast memory that enhances the performance of computer processor(s) 404 by holding recently accessed data, and data near accessed data, from memory 406.

Program instructions for the project activity structuring program may be stored in the persistent storage 408 or in memory 406, or more generally, any computer readable storage media, for execution by one or more of the respective computer processors 404 via the cache 416. The persistent storage 408 may include a magnetic hard disk drive. Alternatively, or in addition to a magnetic hard disk drive, the persistent storage 408 may include, a solid state hard disk drive, a semiconductor storage device, read-only memory (ROM), electronically erasable programmable read-only memory (EEPROM), flash memory, or any other computer readable storage media that is capable of storing program instructions or digital information.

The media used by the persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of the persistent storage 408.

The communications unit 410, in these examples, provides for communications with other data processing systems or devices. In these examples, the communications unit 410 may include one or more network interface cards. The communications unit 410 may provide communications through the use of either or both physical and wireless communications links. The project activity structuring program may be downloaded to the persistent storage 408 through the communications unit 410. In the context of some embodiments of the present invention, the source of the various input data may be physically remote to the computer 400 such that the input data may be received and the output similarly transmitted via the communications unit 410.

The I/O interface(s) 412 allows for input and output of data with other devices that may operate in conjunction with the computer 400. For example, the I/O interface 412 may provide a connection to the external devices 418, which may include a keyboard, keypad, a touch screen, and/or some other suitable input devices. External devices 418 may also include portable computer readable storage media, for example, thumb drives, portable optical or magnetic disks, and memory cards. Software and data used to practice embodiments of the present invention may be stored on such portable computer readable storage media and may be loaded onto the persistent storage 408 via the I/O interface(s) 412. The I/O interface(s) 412 may similarly connect to a display 420. The display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
identifying a software development project profile;
identifying one or more project activity data artefacts, said one or more project activity data artefacts being associated with said software development project profile;
determining one or more structured project activity data artefacts based on said one or more project activity data artefacts;
determining one or more structural mapping conclusions based on said one or more structured project activity data artefacts; and
determining one or more project structural conclusions based on said one or more structural mapping conclusions, said one or more project structural conclusions being associated with said software development project profile.

2. The computer-implemented method of claim 1, wherein said one or more project activity data artefacts are identified based on one or more project activity sources selected from the group consisting of:
one or more group collaboration sources;
one or more mail channel sources;
one or more documentation sources;
one or more organization historical data sources; and
one or more audiovisual conference record sources.

3. The computer-implemented method of claim 1, wherein determining said one or more structural mapping conclusions further comprises:
determining one or more natural language analysis conclusions based on said one or more structured project activity data artefacts;
determining one or more data segmentation conclusions based on said one or more natural language analysis conclusions; and
determining one or more cognitive inferential conclusions based on said one or more data segmentation conclusions.

4. The computer-implemented method of claim 1, wherein determining said one or more project structural conclusions further comprises:
determining one or more use case characterizations based on said one or more structural mapping conclusions, said one or use case characterizations being associated with said software development project profile; and
determining, for each of said one or more project activity data artefacts, one or more legacy statistical data artefacts.

5. The computer-implemented method of claim 1, wherein said one or more project structural conclusions are selected from the group consisting of:
one or more use case model conclusions; and
one or more operational model conclusions.

6. The computer-implemented-method of claim 1, further comprising:
identifying a user profile;
determining one or more project development information artefacts based on said one or more project structural conclusions; and
presenting said one or more project development information artefacts to said user profile.

7. The computer-implemented-method of claim 6, wherein:
said one or more project development information artefacts comprise at least one of one or more source information artefacts, one or more historical project structure artefacts, and one or more conclusion indicator information artefacts; and
presenting said one or more source information artefacts to said user profile is performed in response to identifying a mouse cursor input indicator, said mouse cursor input indicator being associated with at least one of said one or more project development information artefacts.
